(19) United States
(12) Patent Application Publication
(10) Pub. No.: US 2012/0218103 A1
(43) Pub. Date: Aug. 30, 2012

(54) Item Locator with Distance Determining Capabilities

(76) Inventors: Manuel Alves, Calgary (CA); Jeannie Alves, Calgary (CA)

(21) Appl. No.: 13/363,522

(22) Filed: Feb. 1, 2012

Related U.S. Application Data
(60) Provisional application No. 61/447,327, filed on Feb. 28, 2011.

(51) Int. Cl. G08B 1/08

(52) U.S. Cl. 340/539.32

(57) ABSTRACT

Disclosed is an item locator that utilizes a transmitter and a receiver. The receiver is attached to an item that may become lost or misplaced, and a signal is sent from the transmitter to the receiver, causing the receiver to emit an audible, visual, and vibratory alert when activated. A receiver is placed on a wallet, cell phone or other frequently misplaced item. The alarms appeal to multiple senses, allowing an individual to rely on their strongest and sharpest senses to locate the items or choose a preferred method. In addition, the receiver includes a range measuring means for providing the distance between the transmitter and the misplaced item. The range measuring means preferably functions off of a sent radio signal and a received signal from the receiver attached to the misplaced item, wherein the time delay provides a distance measurement thereto.

### CROSS REFERENCE TO RELATED APPLICATION

This application claims the benefit of U.S. Provisional Application No. 61/447,327 filed on Feb. 28, 2011, entitled “Item Locator.”

### BACKGROUND OF THE INVENTION

1. Field of the Invention

The present invention relates to a personal item locator tool. More specifically, the present invention pertains to a new personal item locator for lost and misplaced items that is capable determining the location and distance to a specified object based on a receiver feedback to a transmitter and sensory signals to the user to allow improved location of the misplaced item attached to the receiver.

Individuals spend a considerable amount of time searching for lost and misplaced items. Items such as mobile phones, keys, wallets, and purses continue to shrink in size, making them more difficult to locate once misplaced. The time spent looking for such misplaced item is time wasted that can otherwise more efficiently be spent working, spending time with family, and engaging in personal hobbies. To alleviate the stress of locating these items, individuals use a variety of item locator systems that utilize a transmitter and a receiver. The receiver is attached to an item that may become lost or misplaced, wherein a signal is sent from the transmitter to the receiver, causing it to emit an audible or similar sensory alert. Traditional item location systems emit only sounds signals, and do not provide location signals detectable by multiple senses for sensory impaired individuals, and further do not include a location determining means.

The present invention improves upon item locators by utilizing a receiver attachable to an item that emits an audible alarm, illuminates and vibrates when activated. A receiver is placed on a wallet, cell phone, or other frequently misplaced item. These alarms may appeal to multiple senses, allowing an individual to rely on their strongest and sharpest senses to locate the items. In addition, the receiver includes a location determining means, alerting an individual of the distance between the transmitter and the misplaced item. Knowing the distance between the transmitter and receiver can be utilized if all sensory indication alerts are exhausted, whereby the distance can be tracked as the user consecutively transmits the outgoing signal.

The structure of the present device includes a central transmitter having a plurality of discrete receivers which can be individually signaled. This provides a central transmitter device that can track and locate a plurality of items and personal items, wherein each receiver is mated with a different article being sought. The transmitter signal is chosen for a corresponding article, which can be labeled for user clarity, wherein that specific receiver will initiate a return signal for determining distance, while also initiating its sensory feedback signals for direct location by a user.

2. Description of the Prior Art

Several devices have been disclosed in the art that locate lost and misplaced items. Many of the devices locate an item by emitting a sound alert. Hill, U.S. Pat. No. 6,956,475 discloses a selectable lost item locator system for finding particular items either misplaced or lost. The selectable lost item locator system includes a transmitter assembly including a housing, a first microprocessor and a variable radio transmitter being disposed in the housing and being connected to one another; it also includes a plurality of receiver assemblies each including a housing member, along with a radio receiver being disposed in the housing member and a sound-producing member being attached to the housing member and being connected to the radio receiver. Ferrier, U.S. Patent Application Publication No. 2003/0058107 discloses a personal item unit that is attached to a personal item to be located and includes a personal item antenna, a personal item receiver, a personal item controller, a personal item audio output device and a personal item battery contained in a housing. The personal item housing includes a resonating cavity for the personal item audio output device. Knave, U.S. Pat. No. 6,501,378 discloses an item locator system for locating lost personal articles. A speaker emits an audible sound, which is operationally coupled to the microprocessor and actuated when the first transceiver receives a signal. While such devices are proficient at locating misplaced items, they are not useful for individuals who suffer from a hearing impairment. They fail to provide several means of notifying the user of the item location, along with an inability to determine distance thereto.

Some devices use existing wireless protocols to locate misplaced items, such as Bluetooth. Wingren, U.S. Pat. No. 6,735,444 discloses a system and method for locating objects using a wireless communication interface for performing searches for specified objects. Initially, a location request for a specified device is transmitted via a local wireless interface, such as a Bluetooth radio interface, by a request origination device. A separate device receives the location request, either directly or via one or more other devices that use the local wireless interface, and forwards the location request via the local wireless interface. When the separate device receives a response to the forwarded location request from the specified device, the separate device sends a message to the request origination device that includes information relating to a location of the specified device. Because devices such as these require the use of a secondary Bluetooth device, they are not useful for items that are lost or misplaced at a distance from the secondary device due to Bluetooth's limited transmitting range.

Other devices in the prior art utilize sight and sound transmitters. Rosenthal, U.S. Pat. No. 6,366,202 discloses a lost item finding system including at least two nearly identical locators. Either one can be used to find the other and whatever items are attached to it. Preferably, the search signal includes a sequence of tones having predetermined frequency differences between them. The lost locator transmits a beacon signal that can be perceived by the user as he searches for the lost item. The beacon signal may include both an audible signal and a flashing light emitting diode. Parker, U.S. Patent Application Publication No. 2005/0168338 discloses an apparatus for assisting in the location of lost or misplaced objects. Receivers are coupled to objects that are likely to be misplaced. The pager device sends a signal to a select one of a number of receivers which then can emit an audible multi-frequency sound and/or emit light. While such devices are useful for users with a hearing impairment, they will not assist a user who having a hearing impairment if the misplaced item is not in their line of sight. They also do not include a location determining means, thereby allowing an individual to view their distance from a misplaced item.

The item locators disclosed in the prior art locate lost and misplaced items with receivers that emit a visible or audible signal. Such devices are difficult to use for individuals with hearing impairments searching for misplaced items that are not within their direct line of site. The present invention utilizes an audible, visual, and vibrating signal, allowing location via multiple sensory inputs while in search of a missing item. The device also includes a location determining means to notify a user of their approximate distance from the misplaced items, ensuring the user is within proximity to allow for the location identifying means to be perceived. The present invention substantially diverges in design elements from the prior art and consequently it is clear that there is a need in the art for an improvement to existing item location devices. In this regard the instant invention substantially fulfills these needs.

### SUMMARY OF THE INVENTION

In view of the foregoing disadvantages inherent in the known types of item location devices now present in the prior art, the present invention provides a new item location devices wherein the same can be utilized for providing convenience for the user when searching for lost and misplaced items using a device that transmits several sensory signals and a distance measuring capability to improve one's ability to find misplaced articles.

It is therefore an object of the present invention to provide a new and improved item location device that has all of the advantages of the prior art and none of the disadvantages.

It is another object of the present invention to provide a new and improved item location device that assists a user in finding misplaced and lost items.

Still another object of the present invention is to provide a new and improved item location device that utilizes a transmitter that communicates with a receiver attached to an article to allow improved retrieval if ever lost or misplaced.

Yet another object of the present invention is to provide a new and improved item location device that includes a receiver that emits a plurality of sensory alert signals when a radio signal is received from the transmitter, including light, sound, and vibration output.

Another object of the present invention is to provide a new and improved item location device that includes a location determining means to notify a user of a receiver distance from a paired transmitter device.

A final object of the present invention is to provide a new and improved item location device that is easy to initialize, set up and use on a regular basis.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the elements of the present invention, comprising a transmitter body with a housing, an enlarged annular attachment, a receiver selection button, a plurality of openings to display sheets of material, a display, and a plurality of receiver assembly tags.

FIG. 2 shows a diagram of the components within the housing, comprising a first microprocessor, a radio, a location means transmitter, a signal transmitter and a power source. Also shown is a diagram of the receiver assembly tag components, comprising a second microprocessor, a receiver, a power source, a light alert, a sound alert, a vibrating alert and location means receiver

FIG. 3 shows a perspective view of the present invention, including an individual selecting the receiver selection button on the transmitter body.

### DETAILED DESCRIPTION OF THE INVENTION

Reference is made herein to the attached drawings. Like reference numerals are used throughout the drawings to depict like or similar elements of the item location device. For the purposes of presenting a brief and clear description of the present invention, the preferred embodiment will be discussed as used for locating objects using several sensory feedback means. The figures are intended for representative purposes only and should not be considered to be limiting in any respect.

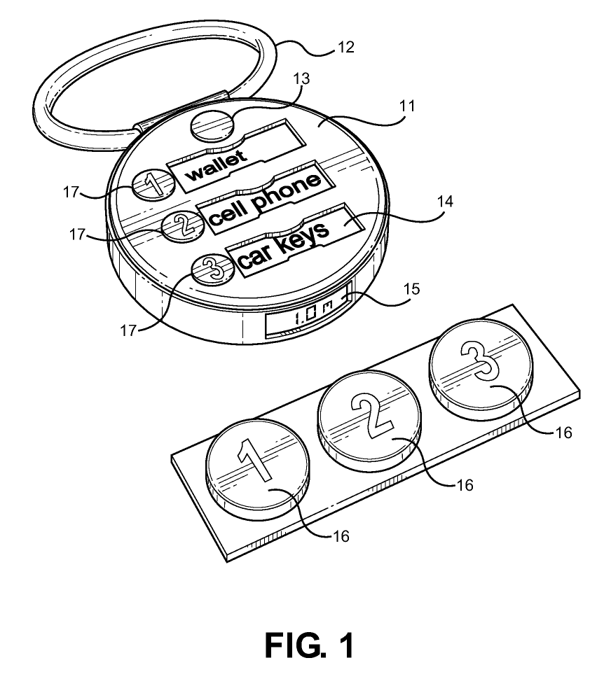

Referring now to FIG. 1, there is shown a perspective view of the item location device of present invention including all of its elements, comprising a transmitter body having a housing 11, an annular attachment 12 for connecting the housing to a larger structure, and operational controls for a user to choose a specific receiver to send a signal to and locate a particular article. The housing exterior comprises a plurality depressible buttons for which communication to a specific receiver is controlled. The device operates by sending radio signals from the central housing to a particular receiver tag 16. Several receiver tags 16 may be placed throughout a home and on a plurality of articles for which misplacement is common or highly undesirable. A plurality of receiver-specific selection buttons 17 are provided that correspond to a user's choice for finding a specific receiver tag 16 attached to the target article. Once a selection is made, a transmission initiate button 13 is depressed to activate the specific receiver tag sensory output for rapidly locating the tag and its attached article. A plurality of display openings 14 adjacent to the selection buttons 17 provide display sheets of indicia material for which to notify a user of which tag 16 is connected to an article of interest, such as a wallet, cell phone, keys or similar personal article being sought after.

Within the body of the housing 11 is electronic circuitry and electrical elements that provide functionality of the device. Each of the selection buttons 17 provide input to a microprocessor to choose a particularly paired receiver tag 16. The signal initiate button 13 signals the microprocessor to initiate an outgoing radio transmission in a frequency that is paired with a given receiver tag, wherein the tags 16 each provide an imbedded receiver antenna, transmission antenna and similar electronic control. The tag responds to its particular signal and initiates a sensory output for which a user to easily locate the device. This sensory output may include audio, visual and vibratory signals that aid in the location of the tag and its attached article. In a particular embodiment, the tag 16 responds to the incoming signal and responds with a corresponding return transmission. A time delay between outgoing signal transmission and the incoming signal provide a means of calculating an approximate distance between the housing 11 and a particular tag 16. The calculated distance is then displayed 15 on the housing 11 for improving the user's ability to locate a specific target item being sought after. The operation of calculating a time lag between an outgoing signal and an incoming signal is considered one contemplated embodiment of the distance determining means of the present invention.

The display 15 is a liquid crystal display or similar digital display that indicates the approximate distance between the housing 11 and the receiver tag 16 calculated by the distance determining means. The receiver tags 16 include attachment means for affixing to a lost or misplaced item, allowing the tag to travel with the item and thus always allow for its retrieval using the disclosed device. This can include a key ring, a rip and stick attachment, or an adhesive material.

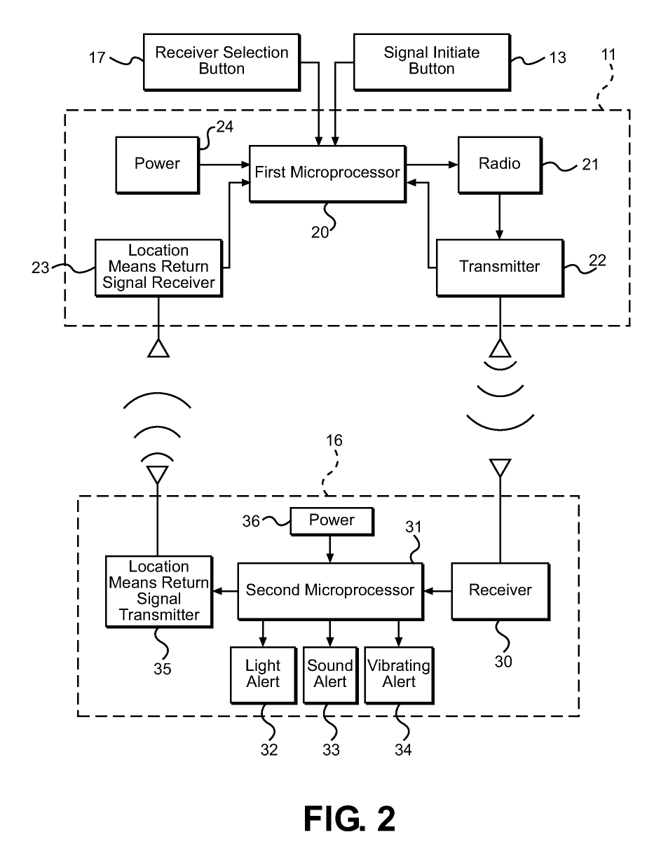

Referring now to FIG. 2, there is shown a schematic flow diagram of the electrical components within the housing 11 and each receiver tag 16. The heart of the electronics within the housing is a microprocessor controller 20 that is coded to interpret incoming signals, make calculations based on several inputs and send outputs based on user demand. When a user is looking for a specific receiver tag 16, a corresponding receiver selection button 17 is depressed, sending an electrical input to the microprocessor 20. This input notifies the microprocessor 20 that a particular receiver signal is desired and therefore will only send out signals therefor. Upon depression of the signal initiation button 13, a signal is sent to the microprocessor 20 to send a signal corresponding to the chosen receiver selection 17. A signal is then output from the microprocessor to a radio 21, which is then transmitted by an outgoing transmitter 22. Radio waves propagate a given distance during this transmission and are received by the corresponding tag receiver 30. Once the outgoing transmission initiates, the time is marked by the microprocessor.

The receiver 30 of the tag 16 accepts the incoming transmission from the housing transmitter 22 and sends a signal to a microprocessor 31 therein. This second microprocessor 31 then initiates one or a plurality of sensory alerts, depending on the construction of the tag and the level of sophistication desired for each tag. These alerts may include an illuminating or flashing light alert 32, an audible sound alert 33 and/or a vibratory alert 34 to provide one or a plurality of sensory signals for which a user to listen, see or feel for the tag location. Simultaneously, the microprocessor sends an outgoing signal to the location means return transmitter 35, which sends an outgoing transmission to be received by the location means return signal receiver 23 of the present device housing 11. The time between signal transmission and receipt can be utilized to estimate the distance to a given tag. Farther distances may be more accurate, wherein tags in close proximity to the housing may not be able to accurately distinguish the outgoing and incoming signals based on the rapid speed with which this operation occurs. However, the distance measurement is provided as a backup system to the preferred method of utilizing the user's senses to locate an alert from an activated tag.

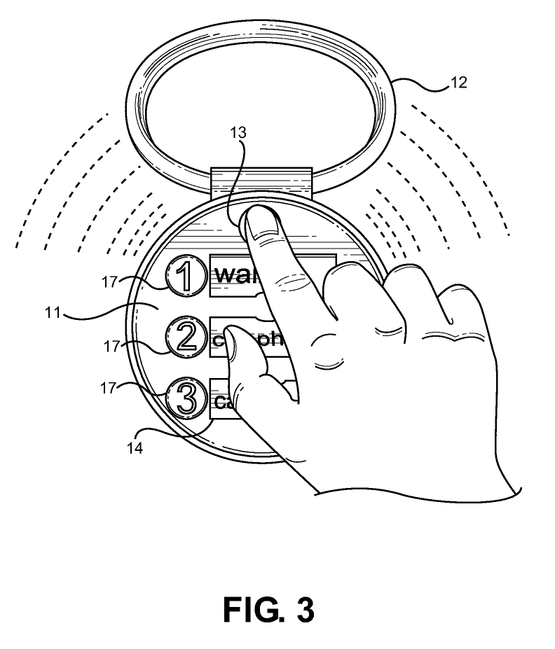

To locate a lost or misplaced item attached to a receiver 16, an individual identifies the appropriate receiver assembly tag 16 to send a signal thereto. As shown in FIG. 3, the signal initiate button 13 is depressed after a particular receiver selection button 17 is chosen, corresponding to a tag connected to a particular item of interest. This causes the first microprocessor 20 to signal the radio 21 and emit a selected radio frequency. The radio frequency is received by the signal receiver 30 of the specific locator tag and sends a signal to the second microprocessor 31. The second microprocessor 31 signals an alert 32 and sends a return signal for distance calculation.

In addition to an audible and visual alert, the receiver assembly tag 16 includes a vibratory alert 34. While receiver assembly tags that include lights and sound are known in the art, the addition of the vibrating alert 34 is a novel feature of the present invention. The vibrating alert 34 allows a user to locate a lost or misplaced item by touch. When in close proximity to the receiver assembly 16, a user may feel the vibrations emitted from the receiver assembly 16. This gives users who are hearing impaired or vision impaired another means of locating a lost or misplaced item. The vibrations may also create an audible alert that improves location of an item if the sound alert is muffled or unheard.

The location means combined with the vibrating alert 34 gives an individual with a hearing or visual impairment a method of locating their lost or misplaced item that does not depend on sight or sound. A sensory impaired individual can use the location means to position himself or herself in close enough proximity to the receiver 16 to feel the vibrating alert 34. This allows a user who cannot hear the audible alarm or see the visible alarm to find a lost or misplaced item.

The receiver tabs may take any structure that is suitable for containing the necessary electronics and alert mechanisms to operate the present system, while also providing a means to attach or otherwise connect to a commonly misplaced item. This may include an outer adhesive surface, a key chain or similar structure for providing connection between objects. Similarly, the housing of the present invention may take any form, shape or material such that the interior electronics are protected while the exterior user interface provides the ability for a user to initiate an outgoing signal and choose between a plurality of receiver tags. Power is provided to each element of the system via battery power, which may be replaceable or optionally rechargeable if desired.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimal dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A device for locating a lost or misplaced item comprising:
a housing having a radio transmitter, a radio receiver, and a user interface;
at least one receiver tag adapted to be connected to an article of interest, said tag having a radio receiver, a sensory alert signal, and a radio transmitter,
said housing and said tag being battery powered;
said housing transmitter adapted to send a signal to said tag receiver to initiate said tag sensory alert signal;
said tag transmitter adapted to send a return signal to said housing receiver upon receiving said housing transmission for calculation of distance therebetween.

2) The device of claim 1, wherein said sensory alert signal comprises at least one of the following:
an illuminating light alert; an audible sound alert; a vibratory alert.

3) The device of claim 1, wherein said housing user interface further comprises:
a receiver selection button for choosing to locate a specific tag between a plurality thereof;
a signal initiate button for transmitting a signal corresponding to said receiver selection.

4) The device of claim 3, further comprising a display opening adjacent to each receiver selection button for providing indication of what tag corresponds to what item being sought after.

5) The device of claim 1, wherein said housing further comprises an internal microprocessor for receiving inputs from said receiver selection and signal initiate buttons, radio receiver and said housing transmitter, and further providing outputs to control said radio transmission to a specific tag;
said tags further comprising an internal microprocessor for receiving inputs from said tag signal receiver, and further providing outputs to control said sensory alert signals and a return signal transmission to said housing;
said housing microprocessor adapted to calculate said housing and tag distance based on outgoing and incoming transmissions.

6) A device as in claim 2, wherein said transmitter includes a plurality of radio frequencies programmed in said first microprocessor to correspond to a plurality of different receiver tags
